(19) United States
(12) Patent Application Publication
(10) Pub. No.: US 2011/0063442 A1
(43) Pub. Date: Mar. 17, 2011

(54) INTERACTION SYSTEM AND METHOD

(75) Inventors: Ronaldus Maria Aarts, Eindhoven (NL); Bartel Marinus Van De Sluis, Eindhoven (NL)

(73) Assignee: KONINKLIJKE PHILIPS ELECTRONICS N.V., EINDHOVEN (NL)

(21) Appl. No.: 12/992,092

(22) PCT Filed: May 7, 2009
(86) PCT No.: PCT/IB09/51874

§ 371 Date: Nov. 11, 2010

(30) Foreign Application Priority Data
May 14, 2008 (EP) 08103957.0

(51) Int. Cl. H04N 7/18; G08B 23/00

(52) U.S. Cl. 348/143; 340/573.1; 348/E07.085

(57) ABSTRACT

The invention relates to an interaction system and method for automatically generating a soundscape and lighting, which are adapted to an action of a viewer of displayed items, in order to attract the attention of the viewer to one or more of the displayed items, such as products presented in a shop or displayed in a shopping window. A basic idea of this invention is refining interactivity by triggering the generation of a lighting and soundscape upon detection of a certain viewer or user action and to adapt the generated lighting and soundscape to the viewer or user action. The invention provides in an embodiment an interaction system (10) comprising—at least one detector (12) being adapted to detect an action of at least one viewer (14) showing interest in displayed items (16) and—a controller (18) being adapted to control a light (20) and sound (22) system in response to information received from the at least one detector such that a soundscape and lighting adapted to the detected action is generated.

### FIELD OF THE INVENTION

The invention relates to an interaction system and method for automatically generating a soundscape and lighting, which are adapted to an action of a viewer of displayed items, in order to attract the attention of the viewer to one or more of the displayed items, such as products presented in a shop or displayed in a shopping window.

### BACKGROUND OF THE INVENTION

To draw peoples attention is more and more a complicated affair. For example, in a shop there are many things to see. However, simply adding sounds or lights to each object or item presented in a shop or displayed in a shopping window would lead to a cacophonic and distracting environment, which is not suitable to attract the shoppers attention to certain items. WO2008/012717A2 discloses an interaction method and system, which include at least one detector configured to detect gazes of at least one viewer looking at items. A processor is configured to calculate gaze durations, such as cumulative gaze durations per item of the items, identify the most looked at item(s) in accordance with the cumulative gaze durations, and provide information related to the most looked at items. A display device displays the information, a list of the most looked at items, representations of the most looked at items, and/or audio/visual show related to at least one item of the most looked at items. At least one item and/or item representation may be displayed more prominently than others ones of the most looked at items and/or item representations.

### SUMMARY OF THE INVENTION

It is an object of the present invention to provide an interaction system and method with a further improved interactivity.

The object is solved by the independent claims. Further embodiments are shown by the dependent claims.

A basic idea of this invention is refining interactivity by triggering the generation of a lighting and soundscape upon detection of a certain viewer or user action and to adapt the generated lighting and soundscape to the viewer or user action. Thus, a certain action, e.g. the view of a customer in a shop to a certain product, may trigger special events like particular sounds and lights or even other modalities. One example is a person, who shows interest by gazing to an object. This action may be detected and trigger a sound and light event focused particularly spatially on the gazed object. Thus, the invention allows refining the interactivity by better adapting the generation of a soundscape and lighting to an user's action, which may result in an increased attention of the user's to the item of interest.

The invention provides in an embodiment an interaction system comprising
at least one detector being adapted to detect an action of at least one viewer showing interest in displayed items and
a controller being adapted to control a light and sound system in response to information received from the at least one detector such that a soundscape and lighting adapted to the detected action is generated.

A viewer may be a person, particularly a shopper in a warehouse, looking around and viewing for example displayed items such as presentation of new products, for example clothes or shoes presented in a shopping window.

According to a further embodiment of the invention, the detector may be a camera being arranged for monitoring an area with the at least one viewer standing before and viewing the displayed items. The camera may be a video or photo camera, wherein the latter may be configured to take periodically pictures. A camera allows obtaining a lot of information from a scene for example in a shop, thus, helping improving the adaptation of the generated soundscape and lighting to viewer's actions. However, the detector may also any kind of sensor, which is able to detect a viewer action, for example a touch sensor or a gaze or gesture detection sensor.

In a further embodiment of the invention, the controller may be adapted to analyze video information received from the camera for characteristics of the at least one viewer and to adapt the control of the light and sound system to the result of the analysis. For example, the controller may process the video information for gestures of the viewer or characteristics of the viewer, for example length, sex, age etc. For example, the controller may detect by video information processing that the viewer is a tall man or a child, or it may detect the viewer's age by analyzing the speed of movement of the viewer, or the viewer's sex by analyzing the shape of the viewer.

The detector may be adapted in a further embodiment of the invention to detect as an action of a viewer one or more of the following: a gazing of the viewer at a displayed item; a touching of a displayed item by the viewer; a pointing of the viewer to a displayed item. These actions can clearly be distinguished and are indications of a viewer's interest in a displayed item, thus, allowing to improve the generation of a suitable soundscape and lighting in order to further increase the viewer's interest in the item.

According to a further embodiment of the invention, the controller may be also adapted to control the light and sound system in response to information received from the at least one detector such that the generated soundscape and/or lighting is spatially limited to a viewer. A spatially limited soundscape may be for example generated by a speaker array, which is controlled by a signal processor for generating a spatially limited soundscape. A spatially limited lighting may be for example generated with a spotlight. The spatial limitation of soundscape and/or lighting allows operating several of the interaction systems in parallel in a shop without resulting in a cacophonic and distracting environment.

The controller may be further adapted in an embodiment of the invention to control the light and sound system in response to information received from the at least one detector such that the generated lighting and/or soundscape is related to the item, in which a viewer shows interest. For example, when a viewer shows interest in a pair of shoes with high heels, the system may generate a soundscape containing the sound of high heels going from left to right and a lighting also wandering from left to right with the sound, finally stopping over the pair of shoes and highlighting it.

A further embodiment of the invention relates to a shop interaction system comprising
a light system with several light units being arranged to illuminate items to be displayed,
a sound system with a loudspeaker array being adapted to create a spatial controllable soundscape, and
an interaction system according to the invention and as described above.

This system could be for example a shelf with an integrated lighting and sound system, which allows to present new products and to attract shoppers attention in the new way according to the present invention.

Further, an embodiment of the invention relates to an interaction method comprising the acts of
detecting an action of at least one viewer showing interest in displayed items and
controlling a light and sound system in response to information received by the detecting of an action such that a soundscape and lighting adapted to the detected action is generated.

The act of detecting may in an embodiment of the invention comprise a monitoring of an area with the at least one viewer standing before and viewing the displayed items and analyzing video information received from the monitoring for characteristics of the at least one viewer.

The act of controlling may in an embodiment of the invention comprise an adapting of the controlling of the light and sound system to the result of the analysis of the video information.

The act of detecting may in an embodiment of the invention comprise one or more of the following acts: detecting a gazing of the viewer at a displayed item; detecting a touching of a displayed item by the viewer; detecting a pointing of the viewer to a displayed item.

The act of controlling may in a further embodiment of the invention comprise the controlling of the light and sound system in response to information received from the at least one detector such that the generated soundscape and/or lighting is spatially limited to a viewer.

The act of controlling may in a further embodiment comprise the controlling of the light and sound system in response to information received from the at least one detector such that the generated lighting and/or soundscape is related to the item, in which a viewer shows interest.

According to a further embodiment of the invention, a computer program may be provided, which is enabled to carry out the above method according to the invention when executed by a computer. Thus, the method according to the invention may be applied for example to existing interactive systems, particularly interactive shopping windows, which may be extended with novel functionality and are adapted to execute computer programs, provided for example over a download connection or via a record carrier.

According to a further embodiment of the invention, a record carrier storing a computer program according to the invention may be provided, for example a CD-ROM, a DVD, a memory card, a diskette, or a similar data carrier suitable to store the computer program for electronic access.

Finally, an embodiment of the invention provides a computer programmed to perform a method according to the invention and comprising an interface for controlling a lighting and sound system.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

FIG. 1 shows an embodiment of an interactive system according to the invention, which may be installed in a shop for product presentations; and

FIG. 2 shows a flow chart of an embodiment of an interactive method according to the invention, which may be performed by a computer implementing a controller of the interactive system of FIG. 1.

### DETAILED DESCRIPTION OF EMBODIMENTS

In the following, functionally similar or identical elements may have the same reference numerals.

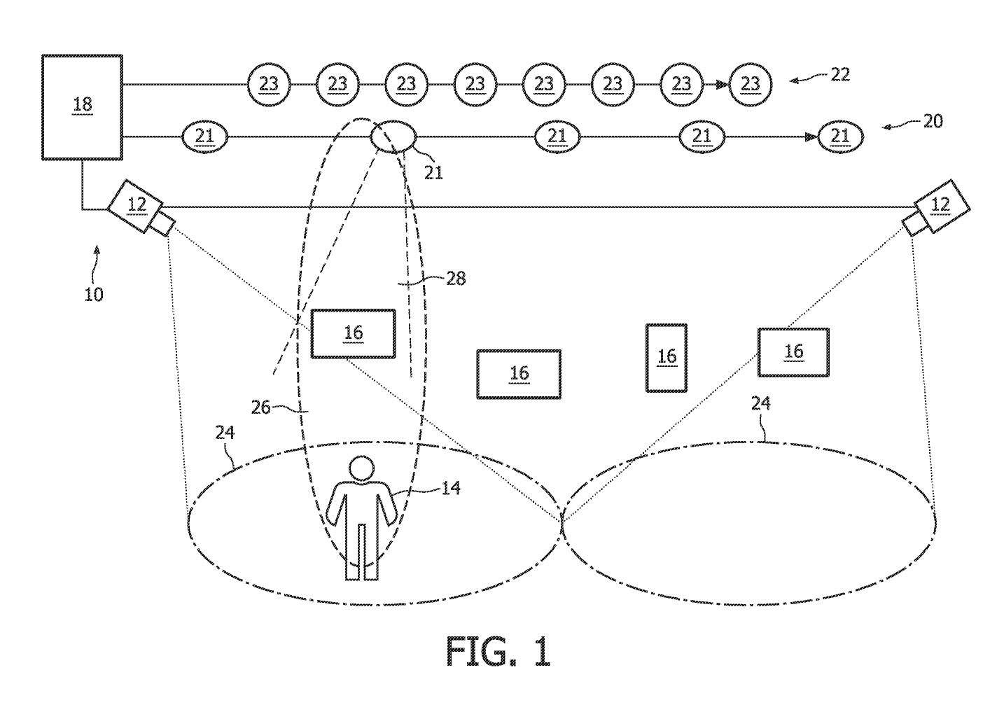

FIG. 1 shows an interactive system 10 for a shop and provided for presenting items. The system 10 comprises two video cameras 12 as detectors and a controller 18 for processing the video information from the video cameras 12 and controlling a light system 20 with several spotlights 21 and a sound system 22 with several loudspeakers 23 in response to the received video information. The light system 20 and the sound system 22 are arranged over some items 16, such as new products. The video cameras 12 are adjusted so that each camera monitors an area 24 before the items 16, which may be for example located in a shelf or on a board in the shop.

The video information from the cameras 12 is transmitted to the controller 18. The controller 18 is a computer configured to process the received information in that it detects actions of a viewer 14 in the monitored areas 24. The actions may be for example gazing of one of the presented items 16, pointing to one of the items 16 or other actions like gestures, movement, walking, bending down to be able to better see an item 16 or the like. An action may in the context of the present invention also comprise the position of the viewer or personal characteristics of the viewer, such as the length, sex or age of the viewer. These characteristics may be obtained by processing the received video information with image processing software, which is able to determine a person from a video, estimate the length of the person and the sex, for example by analyzing the person's shape. Thus, the controller 18 may obtain several information regarding actions of the viewer 14 from the processing and analyzing of the video information. It should be noted that also other detectors may be applied such as infrared presence, movement detectors. It is essential for the purpose of the invention that a detector must be able to detect at least one action of a person in a surveillance area such as pointing to an item or movement in a certain direction.

The controller 18 is further adapted to control the light system 20 and sound system 22 in response to the received video information in the following way: depending on the detected action, an action adapted soundscape and lighting is generated. This generation may be preprogrammed in the controller; for example, when the viewer 14 gazes to a certain item 16, a spatial limited soundscape 26 related to the certain item 16 may be generated, and a spotlight 28 may illuminate the certain item 16 so that it is accentuated among the items 16. The generated soundscape may be for example a typical sound, which is related to the item, but also stimulating music, or information about the product. By spatially limiting the automatically generated soundscape, and by spatially limiting the generated illumination, interference with other interactive systems in the shop can be avoided. The generation of a spatially limited soundscape may be performed with a signal processor, which may control the loudspeakers 23 of the array such that a soundscape is generated, which is directed to the viewer's position and restricted to a certain area where the viewer stands.

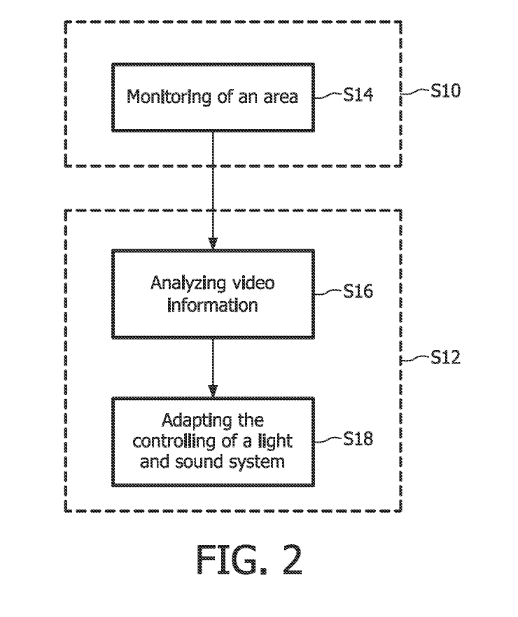

FIG. 2 shows a flow chart of an algorithm implementing an embodiment of the interactive method according to the invention. This algorithm may be implemented in the controller 18 and executed by a processor of the controller 18. The method comprises a first step S10 for detecting actions of the viewer 14 and a second step S12 for controlling the light system 20 and the sound system 22 in response to the actions, detected in step 10.

Step S10 comprises a step S14 for monitoring the areas 24. This step may also comprise the control of the detectors, such as the video cameras in order to monitor certain areas before the items to be presented, for example the focusing of the video cameras on the areas to be monitored and the transmittal of information from the detectors, such as video information from the video cameras for further processing.

Step S12 comprises a step S16 for analyzing the information received from the monitoring of the areas, particularly the processing and analyzing of video information for detecting actions of viewers 14, as described above with regard to FIG. 1. In this step, the received information is processed by dedicated algorithms for action detection in the received information, for example for processing the pictures taken by video cameras in order to detect a person in a picture and to determine a certain action of the person as recorded with the pictures. In order to accomplish this task, image recognition and processing algorithms may be used. In a further step S18 of the step S12, the controlling of the light and sound system is adapted in accordance with the result of the analysis and processing preformed in step S16. This comprises for example the generation of a certain soundscape and spotlighting if the analysis resulted in that a viewer showed interest in a certain item, for example gazed at the item or pointed to this item. The soundscape may be loaded from a sound library stored in a database with soundscapes related to the presented items. The lighting may be for example adapted in that the light system activates a spotlight which illuminates the item of interest so that the viewer can better see the item.

Summarizing the above, one essential feature of the invention is that a certain action, e.g. the view of a customer in a shop to a certain product, may trigger events like sound, light or other modalities, or combinations of them. Particular areas of the store, the presence or a specific behavior of the shopper could trigger the playback of a soundscape. For instance, the area of dress suits or evening dresses could trigger the sound of a stylish dinner or of the sound that can be heard in a theatre just before the performance starts. Or, an area with sportswear can trigger the sound of a sports event. The sounds may be produced at a low intensity level in order not to disturb other shoppers. The sound may be spatially limited to the view of sight of the user using loudspeaker arrays. Aspects like the shopper's length, sex, age may determine the stimulus, e.g. elderly dislike ‘flashy and hectic effects, while they are appreciated by children. Also, a reactive spotlight, which upon detecting human presence adapts the properties of the lighting and reproduces a soundscape which relates to the experience associated with the product. See examples of the first embodiment. It would be possible to add spatial effects, for instance, for a pair of shoes with high heels, the sound of high heels could go from left to right, or it could accompany the shopper in the direction he or she is going.

The invention may be particularly applied for shops, exhibitions or any other environment to draw someone's attention to items or objects.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. An interaction system (10) comprising
at least one detector for detecting an action of at least one viewer relative to one or more displayed items (16) and
a controller for controlling at least one of a light (20) and sound (22) system in response to information received from the at least one detector such that a soundscape and lighting adapted to the detected action is generated.

2. The system of claim 1, wherein the detector is a camera (12) being arranged for monitoring an area (24) with the at least one viewer (14) standing before and viewing the displayed items (16).

3. The system of claim 2, wherein the controller analyzes video information received from the camera (12) for characteristics of the at least one viewer and to adapt the control of the light and sound system to the result of the analysis.

4. The system of claim 1, wherein the detector detects as an action of a viewer one or more of the following: a gazing of the viewer at a displayed item; a touching of a displayed item by the viewer; a pointing of the viewer to a displayed item.

5. The system of claim 1, wherein the controller controls the light and sound system (20, 22) in response to information received from the at least one detector (12) such that the generated soundscape and/or lighting is spatially limited to a viewer.

6. The system of claim 1, wherein the controller controls the light and sound system (20, 22) in response to information received from the at least one detector (12) such that the generated lighting and/or soundscape is related to the item, in which a viewer shows interest.

7. A shop interaction system comprising
a light system (20) with several light units (21) being arranged to illuminate items to be displayed,
a sound system (22) with a loudspeaker array (23) being adapted to create a spatial controllable soundscape, and
an interaction system (10) of claim 1.

8. An interaction method comprising the acts of
detecting an action of at least one viewer showing interest in displayed items (S10) and
controlling a light and sound system in response to information received by the detecting of an action such that a soundscape and lighting adapted to the detected action is generated (S12).

9. The method of claim 8, wherein the act of detecting comprises a monitoring of an area with the at least one viewer standing before and viewing the displayed items (S14) and comprises analyzing video information received from the monitoring for characteristics of the at least one viewer (S16).

10. The method of claim 9, wherein the act of controlling adapting the controlling of the light and sound system to the result of the analysis of the video information.

11. The method of claim 8, wherein the act of detecting comprises one or more of the following acts: detecting a gazing of the viewer at a displayed item; detecting a touching of a displayed item by the viewer; detecting a pointing of the viewer to a displayed item.

12. The method of claim 1, wherein the act of controlling further comprises the controlling of the light and sound system in response to information received from the at least one detector such that the generated soundscape and/or lighting is spatially limited to a viewer.

13. The method of claim 8, wherein the act of controlling further comprises the controlling of the light and sound system in response to information received from the at least one detector such that the generated lighting and/or soundscape is related to the item, in which a viewer shows interest.

14. A computer program enabled to carry out the method according to claim 8 when executed by a computer.

15. A record carrier storing a computer program according to claim 14.
